(19) United States
(12) Patent Application Publication
(10) Pub. No.: US 2006/0152829 A1
(43) Pub. Date: Jul. 13, 2006

(54) Device for adjusting an optical mirror

(76) Inventors: Joerg Stierle, Waldenbuch (DE); Peter Wolf, Leinfelden-Echterdingen (DE); Kai Renz, Leinfelden-Echterdingen (DE); Clemens Schulte, Stuttgart (DE)

Correspondence Address: Striker Striker & Stenby, 103 East Neck Road, Huntington, NY, 11743, US

(21) Appl. No.: 10/523,467

(22) PCT Filed: Dec. 10, 2003
(86) PCT No.: PCT/DE03/04069

§ 371 Date: Feb. 1, 2005

(30) Foreign Application Priority Data
Mar. 20, 2003 (DE) 103 14 772.1

(51) Int. Cl. G02B 5/08

(52) U.S. Cl. 359/843

(57) ABSTRACT

A device for adjusting an optical mirror (33) is disclosed, which has a mirror holder (36), which receives the mirror (33) and is held on a holder profile section (40), and three adjusting pins (37), which pass through threaded bores (42), offset in the circumferential direction from one another in the mirror holder (36), and which are axially adjustable by being screwed into the threaded bores (42) and are braced by their base points (371) on buttresses (43) embodied on the holder profile section (40). For the sake of exact, fast adjustment of the mirror (33), the buttresses (43) are embodied such that on the one hand, they center the mirror holder (36) via the adjusting pins (37), and on the other, at least two buttresses (43) allow the base point (371) of the respective adjusting pin (37) to shift radially outward (FIG. 4).

### PRIOR ART

The invention is based on a device for adjusting an optical mirror as generically defined by the preamble to claim 1.

One such adjusting device is employed for instance in an optical measuring instrument for contactless distance measurement, in particular in a laser distance meter designed as a handheld device, of the kind described for instance in German Patent Disclosure DE 198 04 051 A1. A measuring instrument of this kind has an optical transmission path for transmitting an optical measurement signal, such as laser pulses, and an optical reception path for receiving the reflected measurement signal. In order to achieve the small structural size that is suitable for a handheld device, the optical axes of the transmission path and reception path are each folded by means of an optical mirror, which must be oriented accordingly upon the adjustment of the measuring instrument. In the process, by means of the adjusting device in the transmission path, the optical axis, and in the reception path both the optical axis and the spacing of the optical mirror from an optical receiver, must be adjusted.

### ADVANTAGES OF THE INVENTION

The adjusting device of the invention having the characteristics of claim 1 has the advantage that because of the inventive design of the abutments on the holder profile section, exact and fast adjustment of the mirror is assured even in the event of production variations in the location and orientation of the through holes in the mirror holder and such variations in the threaded pins passed through the through holes. In no adjusting position can production variations cause incorrect clamping of the adjusting device, which would make adjusting the mirror tedious and less exact.

By the provisions recited in the further claims, advantageous refinements of and improvements to the adjusting device defined by claim 1 are possible.

In advantageous embodiments of the invention, the buttresses are embodied in various combinations as a blind bore and as radial longitudinal grooves; in one combination embodiment of the buttresses, instead of a longitudinal groove a flat face, without a guidance function for the base point of the adjusting pin, may be provided.

In one advantageous embodiment of the invention, the adjusting pins are embodied as threaded pins, the through holes are embodied as threaded bores, and freedom from play in the threads is brought about. The lack of play in the thread guarantees exact adjustment of the mirror with extremely slight adjusting distances. In advantageous embodiments of the invention, the following are possibilities for establishing the freedom from play in the thread: coating the thread with plastic, self-forming threads, and spring elements that act upon the threaded pins with a radial pressure force.

### DRAWING

The invention is explained in further detail in the ensuing description in terms of exemplary embodiments shown in the drawing. Shown are:

FIG. 1, a perspective view from below of an instrument module of a distance measuring instrument;

FIG. 2, a section taken along the line II-II in FIG. 1;

FIG. 3, a section taken along the line III-III in FIG. 1;

FIG. 4, an enlarged view of the detail IV in FIG. 3;

FIG. 5, a top view in the direction of arrow V in FIG. 4 with the mirror holder removed;

FIGS. 6 and 7, each, the same view as in FIG. 5 of two modified exemplary embodiments;

FIG. 8, a top view of a spring element for producing the freedom from play of three threaded pins in an adjusting device of FIG. 4;

FIG. 9, a plan view of a threaded pin with a spring element for producing the freedom from play of the threaded pin.

### DESCRIPTION OF THE EXEMPLARY EMBODIMENTS

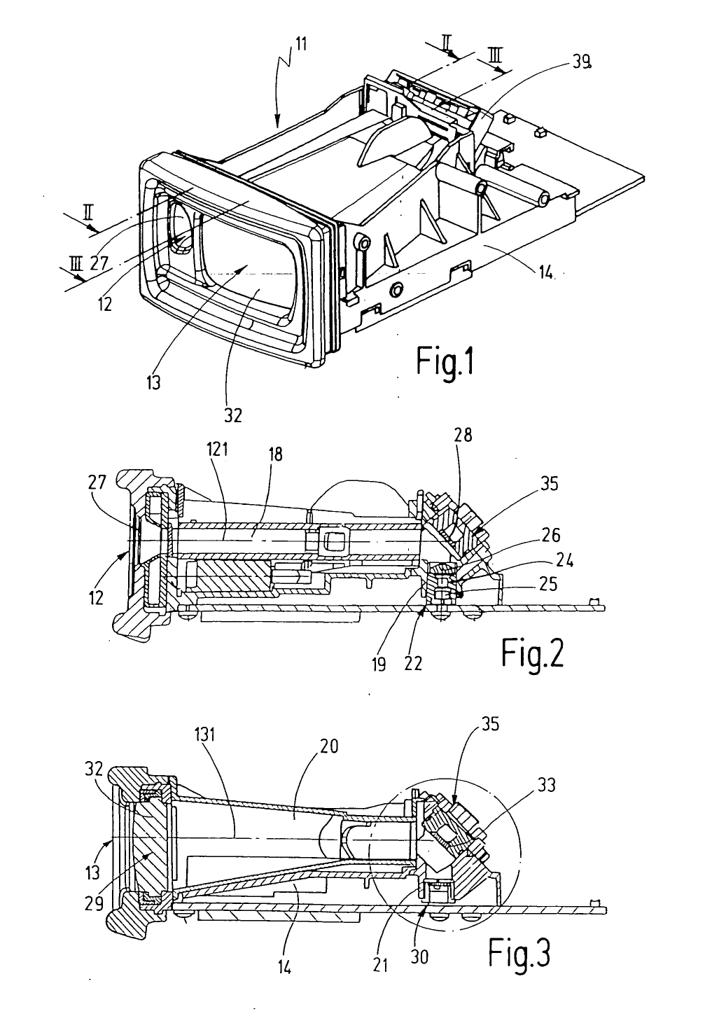

The instrument module 11 of a measuring instrument for contactless measurement of distance, or distance meter or laser distance meter for short, that can be seen from below in perspective in FIG. 1 and in two sectional views in FIGS. 2 and 3, is enclosed by a housing once it has been fully assembled. In the instrument module 11, there are an optical transmission path 12 for transmitting an optical measurement signal and an optical reception path 13 for receiving the measurement signal reflected by an object. To this end, the instrument module 11 has an optical element holder 14, in which the transmission and reception paths 12, 13 are separated from one another by suitably embodied channels and chambers. In FIG. 2, the transmission channel 18 and the transmission chamber 19, which is oriented perpendicular to the transmission channel 18, can be seen, and in FIG. 3, the reception channel 20 and the reception chamber 21 can be seen, the latter also oriented perpendicular to the reception channel 20.

The components of the optical transmission path 12 are an optical transmitter 22, which is embodied as a collimator 24 with a collimator lens 26; a cover plate 27 of glass that closes off the transmission channel 18 at the front; and a deflection mirror 28, located on the other end of the transmission channel 18, which is held adjustably on the optical holder 14. The optical axis 121 of the transmission path 12 can be adjusted via the deflection mirror 28.

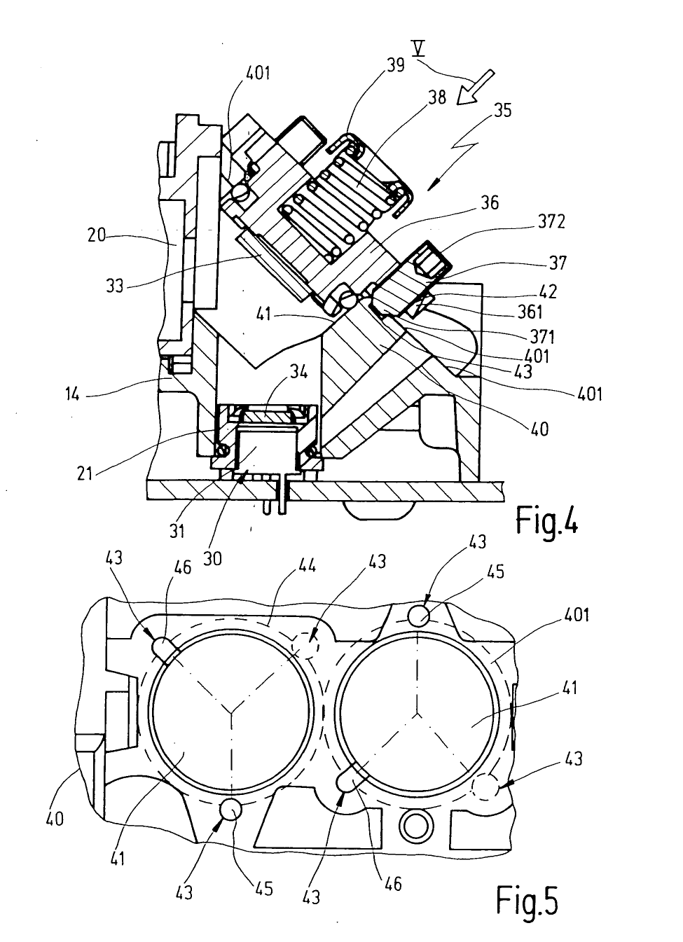

The components of the optical reception path 13 are a receiver optical element 29, in this case a receiver lens 32 that closes off the reception channel 20 at the front and has a long focal length; a deflection mirror 33 placed on the other end of the reception channel 20, the deflection mirror being held adjustably in the optical element holder 14; and a receiver 30, in this case a light detector 31, with a filter 34 (FIG. 4). Via the deflection mirror 33, both the focal spot on the light detector 31 and the direction of the optical axis 131 of the reception path 13 can be varied and adjusted.

Adjusting the deflection mirror 28 in the transmission path 12 and the deflection mirror 33 in the reception path 13 is done by means of one adjusting device 35 each associated with the deflection mirror 28 and the deflection mirror 33, respectively. The adjusting device 35 for the deflection mirror 28 and the adjusting device 35 for the deflection mirror 33 are embodied identically, so that below, only the adjusting device 35 associated with the deflection mirror 33 in the reception path 13 will be described below, in conjunction with the enlarged view shown in FIG. 4. This description applies equally to the adjusting device 35 of the deflection mirror 28 located in the optical transmission path 12.

The adjusting device 35 has a mirror holder 36, made as a diecast part, with an adjusting flange 361, three adjusting pins 37, a compression spring 38, and a spring hoop 39; the spring hoop 39, as can be seen in FIG. 1, is common to both adjusting devices 35 for the deflection mirror 28 and the deflection mirror 33. A holder profile section 40 with a flat profile face 401 is embodied on the optical element holder 14. A circular recess 41 is made in the holder profile section 40, and the mirror holder 36 is inserted into it in such a way that the deflection mirror 33 glued to the mirror holder 36 protrudes into the reception channel 20. Three threaded bores 42, offset by rotary angles to one another in the circumferential direction of the mirror holder 36 on a pitch circle 55 (FIG. 8), are made in the adjusting flange 361, and into each one of them, one adjusting pin 37 embodied as a threaded pin is screwed through it. For rotating the adjusting pins 37, these pins are provided with a hexagonal socket 372. The mirror holder 36 is thrust by means of the compression spring 38, which is braced on the spring hoop 39 secured to the optical element holder 14, into the recess 41 far enough that the base points 371 of the adjusting pins 37 are braced on three buttresses 43, embodied in the profile face 401 of the holder profile section 40, and are retained against the profile face 401. Like the adjusting pins 37, the buttresses 43 are located on a pitch circle 44, which is concentric with the recess 41 and has the same radius of the circle, at rotary angle spacings from one another corresponding to the rotary angle spacings of the adjusting pins 37 (see FIG. 5). The buttresses 43 are embodied such that on the one hand, they center the mirror holder 36 in the recess 41 via the adjusting pins 37, and on the other, at least two buttresses 43 allow the base point 371 of the respective adjusting pin 37 to shift radially outward.

In the exemplary embodiment of FIG. 5, a first buttress 43 is embodied as a blind bore 45, and the second buttress 43 is embodied as a radial longitudinal groove 46. The third buttress 43, indicated by dotted lines in FIG. 5, is formed by the flat profile face 401 of the holder profile section 40. The diameter of the blind bore 45 and the groove width of the radial longitudinal groove 46 are made slightly greater than the outer diameter of the associated adjusting pins 37 at their base point 371. This assures centering of the mirror holder 36 concentrically with the recess 41. Upon rotation of the adjusting pins 37, the longitudinal groove 46 enables the shifting outward of the base point 371. In FIG. 5, the adjacent recess 41 can also be seen, with identically embodied buttresses 43, for receiving the adjusting device 35 for the deflection mirror 28 in the transmission path 12.

By means of the adjusting device 35, the optical axis 131 of the reception path 13 is adjusted such that a measurement signal arriving in the optical axis 131 is deflected positionally correctly onto the light detector 31 of the receiver 30. Simultaneously, the spacing of the deflection mirror 33 from the light detector 31 is also adjusted so that the focal point of the receiver optical element 29 comes to rest on the light detector 31. To that end, the three adjusting pins 37 are rotated variably far in the threaded bores 42 so as to raise or lower and/or tilt the mirror holder 36 and thus the deflection mirror 33 more or less relative to the holder profile section 40.

For an exact adjustment of the deflection mirror 33, the threaded connection between the adjusting pin 37 and the mirror holder 36 is made without play. This can be done by coating the adjusting pin 37 and/or the threaded bore 42 with plastic. For the same purpose, the thread of the adjusting pins 37 may be embodied as self-forming. The freedom from play may, however, also be brought about by means of a spring element, which generates a radial pressure force on the adjusting pin 37, or by other familiar provisions.

With the spring element 47, in the exemplary embodiment in FIG. 8, the radial pressure force on all three adjusting pins 37 is generated by a snap ring 48 that spreads open and is subject to initial tension and that can be employed, with spring-elastic compression of its diametrically opposed ring ends, inside the pitch circle 55 between the three adjusting pins 37. Once the snap ring 48 is released, it presses against the three adjusting pins 37 with a radially outward-oriented pressure force. The snap ring 48 is provided with a twist preventer 49, which is formed by a curved indentation 50 partially embracing an adjusting pin 37.

In the exemplary embodiment of FIG. 9, a clamping sleeve 51 is used as the spring element 54 for bringing about the freedom from play at the adjusting pin 37; it is slit in the axial direction in a known manner, so that it can be compressed spring-elastically, reducing the size of the axial longitudinal slit 52. The clamping sleeve 51 is inserted into a drilled hole 53 made in the holder profile section 40. The axis of the drilled hole 53 has a spacing from the axis of the adjusting pin 37 that has been screwed into the adjusting flange 361 such that the clamping sleeve 51 presses with initial tension radially against the adjusting pin 37.

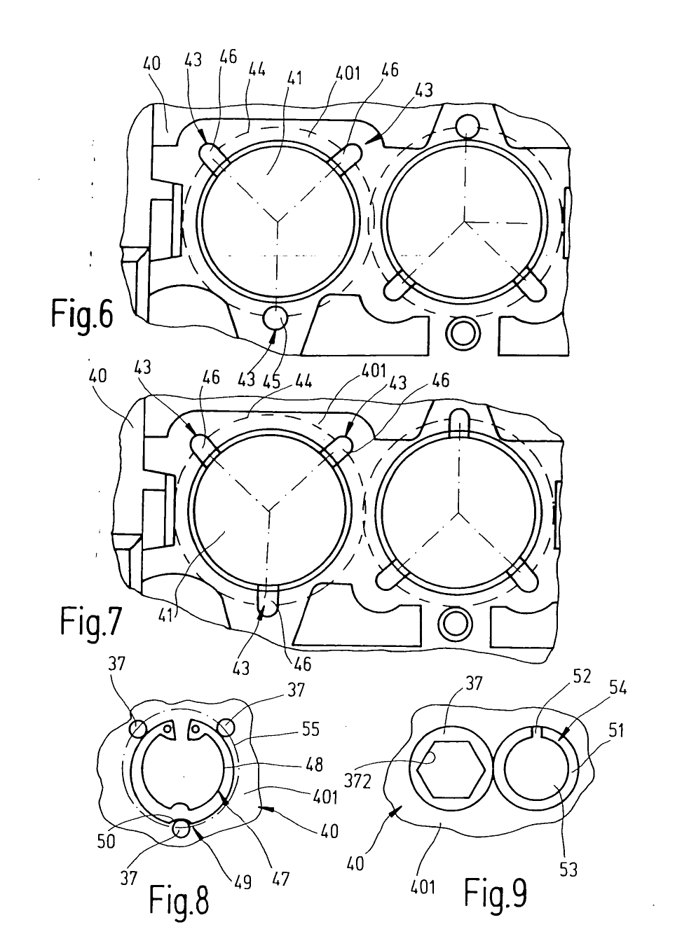

In FIGS. 6 and 7, two exemplary embodiments for possible modifications of the buttresses 43 are shown, in a top view corresponding to FIG. 5. In the exemplary embodiment of FIG. 6, one buttress 43 is embodied as a blind bore 45, and the other two buttresses 43 are embodied as radial longitudinal grooves 46. In the exemplary embodiment of FIG. 7, all three buttresses 43 are embodied as radial longitudinal grooves 46. As in the exemplary embodiment in FIG. 5, the diameter of the blind bore 45 and the width, viewed in the circumferential direction, of the radial longitudinal grooves 46 are each made slightly greater than the outside diameter of the adjusting pins 37 in the region where it dips into the blind bore 45 or into the longitudinal groove 46, respectively. As a result, once again, centering of the mirror holder 36 concentrically with the recess 41 is assured. The radial longitudinal grooves 46 make a radial outward shift of the base points of the adjusting pins 37 possible, so that twisting of the adjusting pins 37 upon adjustment of the deflection mirror 33 is reliably prevented.

The invention is not limited to the exemplary embodiments of the adjusting device 35 described. For instance, the adjusting pins 37 need not be embodied as threaded pins that can be screwed into threaded holes. Instead of the threaded bores, through holes through which the adjusting pins protrude may be provided in the adjusting flange of the mirror holder 36. In that case, means must be provided that enable an axial displacement of the adjusting pins 37 relative to the mirror holder 36, with the axial displacement of the adjusting pins being lockable in any displaced position.

The adjusting pins 37 may be embodied as domelike or conical in their base region that is braced on the buttresses 43, and they may be braced on the preferably chamfered peripheral region of the blind bores 45 or longitudinal grooves 46. As a result, the adjusting pins 37 center themselves in the buttresses 43 and in the same way bring about centering of the mirror holder 36. In FIG. 4, one such embodiment is shown of the adjusting pin 37 and buttress 43 (blind bore or radial longitudinal groove).

1. A device for adjusting an optical mirror (33), having a mirror holder (36) that receives the mirror (33) and is retained on a holder profile section (40), and having three adjusting pins (37), which pass through through holes (42), offset from one another in the circumferential direction in the mirror holder (36), and which are axially adjustable relative to the mirror holder (36) and are braced by their base points (371) on buttresses (43) embodied on the holder profile section (40), characterized in that the buttresses (43) are embodied such that on the one hand, the buttresses (43) center the mirror holder (36) via the adjusting pins (37), and on the other, at least two buttresses (43) allow the base point (371) of the respective adjusting pin (37) to shift radially outward.

2. The device according to claim 1, characterized in that one buttress (43) is embodied as a blind bore (45), and one buttress (43) is embodied as a radial longitudinal groove (46), and the third buttress (43) is formed by a flat face (401).

3. The device according to claim 1, characterized in that one buttress (43) is embodied as a blind bore (45), and the two other buttresses are each embodied as a radial longitudinal groove (46).

4. The device according to claim 1, characterized in that all the buttresses (43) are embodied as radial longitudinal grooves (46).

5. The device according to one of claims 2 through 4, characterized in that the inside diameter of the blind bore (45) and/or the width of the radial longitudinal groove (46) is dimensioned such that the base point (371) of the adjusting pin (37) is received in the blind bore (45) or in the radial longitudinal groove (46), respectively, in the circumferential direction with slight play in each case.

6. The device according to one of claims 2 through 5, characterized in that the base regions of the adjusting pins (37) are embodied in domelike or conical form and rest on a preferably chamfered peripheral region of the blind bores (45) and/or of the radial longitudinal grooves (46).

7. The device according to one of claims 1 through 6, characterized in that the adjusting pins (37) are embodied as threaded pins, and the through holes are embodied as threaded bores (42); and the threads mesh with one another without play.

8. The device according to claim 7, characterized in that the thread of the adjusting pins (37) and/or the thread of the threaded bores (42) is coated with plastic.

9. The device according to claim 7, characterized in that the thread of the adjusting pins (37) is embodied as self-forming.

10. The device according to claim 7, characterized in that the adjusting pins (37) are acted upon with a radial pressure force by a spring element (47) resting on all the adjusting pins (37).

11. The device according to claim 10, characterized in that the spring element (47) is a snap ring (48), which spreads apart under initial tension and which rests inside the pitch circle (55) defined by the adjusting pins (37) and acts upon the adjusting pins (37) with a radially outward-oriented pressure force.

12. The device according to claim 11, characterized in that the snap ring (48) has a twist preventer (49).

13. The device according to claim 7, characterized in that one spring element (54) engages each adjusting pin (37) with radially oriented pressure force.

14. The device according to claim 13 characterized in that the spring element (54) is embodied as an axially slit clamping sleeve (51), which is inserted into a receiving hole (53) made in the mirror holder (36); and the receiving hole (53) has a radial spacing from the threaded bore (42) such that the clamping sleeve (51) presses radially against the adjusting pin (37).

15. The device according to one of claims 1 through 14, characterized by its use in an optical measuring instrument for contactless distance measurement, preferably in a laser distance meter embodied as a handheld device.

16. A measuring instrument for contactless distance measurement, in particular in the form of a laser distance meter embodied as a handheld device, having an optical transmission path (12) for transmitting an optical measurement signal and an optical reception path (13) for receiving the reflected measurement signal, and having at least one deflection mirror (28, 33), located in one of the optical paths (12, 13), for folding the optical axis (121, 131) of the optical path (12, 13), characterized by an adjusting device (35) according to one of claims 1 through 14 that is associated with the deflection mirror (28, 33).
